(19) United States
(12) Patent Application Publication
(10) Pub. No.: US 2004/0003263 A1
(43) Pub. Date: Jan. 1, 2004

(54) Security key for set-top-box updating method

(76) Inventors: Olivier Brique, Le Mont-sur-Lausanne (CH); Christophe Gogniat, Chavannes-pres-Renens (CH); Henri Kudelski, Chexbres (CH)

Correspondence Address: Supervisor, Patent Prosecution Services, PIPER RUDNICK LLP, 1200 Nineteenth Street, N.W., Washington, DC, 20036-2412, US

(21) Appl. No.: 10/607,164

(22) Filed: Jun. 27, 2003

(30) Foreign Application Priority Data
Jun. 28, 2002 (CH) 1126/02

(51) Int. Cl. H04L 9/00

(52) U.S. Cl. 713/189

(57) ABSTRACT

For this reason, the present invention proposes to allow the development of a first security based on a first key towards a second security based on a second key, this operation being carried out in an environment unprotected by said open transmission, guaranteeing the same security level as if this operation was carried out locally in the place belonging to the system manager. This aim is achieved by a security updating method applied to the connection between a decoder and its security unit comprising a first matching key, said decoder being linked to a managing centre, this method having the following steps:

transmission in the decoders, of a shared public key and of an updating programme,

preparation at the managing centre and for each decoder, of a coded message, this message containing a new asymmetric public key coded by the first key of said decoder and by the secret shared key,

carrying out of the updating programme and extraction of the new asymmetric public message key thanks to the global public key and its first key,

storage of this new public key in the decoder.

### The present invention concerns the domain of Pay-TV receivers, in particular the security of the connections between a receiver and its security module.

In a digital television payment system, the digital stream transmitted towards these receivers is encrypted in order to be able to control the usage and define conditions for such usage. This encryption is carried out thanks to “Control Words” that are changed at a regular interval (typically between 5 and 30 seconds) in order to deter any attempt aimed at finding such a control word.

In order for the receiver to be able to decipher the encrypted stream using these control words, the latter are sent independently in a stream of control messages (ECM) encrypted by the transmission system key between the managing centre (CAS) and the user unit security module. In fact, the security operations are carried out in a security unit (SC) that generally takes the form of the reputedly inviolable smart card. This unit can either be of the removable type or directly integrated in the receiver.

The controls words are then returned to the decoder in order to be able to decrypt the encrypted stream.

To prevent these control words being intercepted during their transmission to the decoder, this connection has been secured either by a session key as described in the document WO97/38530 or by a matching key as described in the document WO99/57901.

In the second quoted document, the receiver contains a secret key that matches the security module that is communicated during an initialisation phase. This key can be of a symmetric or asymmetric type. The two devices are thus inseparable from an operational point of view.

Nevertheless, it can be useful to allow this security to evolve, for example to replace a key of a certain technology (key length for example) with another technology.

This operation in itself covers an important fraud risk because it relates to the remote installation of the new security means. It is known that some receivers are in the hands of people hoping to break the security in place.

For this reason, the present invention proposes to allow the evolution of a first security based on a first key towards a second security based on a second key, this operation being carried out in an environment unprotected by said open transmission, guaranteeing the same security level as if this operation was carried out locally in the place that belongs to the system manager.

This aim is achieved using a security updating method applied to the connection between a decoder and its security unit with a first matching key, said decoder being connected to a managing centre, this method having the following steps:

transmission in the targeted decoders, a shared public key and an updating programme,

preparation at a managing centre and for each decoder, of a coded message containing a new asymmetric public key coded by the first key of said decoder and by the shared secret key,

implementation of the updating programme and extraction of the new asymmetric public key message thanks to the global public key and its first key,

storage of this new public key in the decoder.

In this way, a message intercepted and decoded by the previously transmitted shared public key does not permit the discovery of the new public key because only the first private key of the decoder is able to decode the message.

Therefore, this method guarantees that this new key will be installed where the first key is stored. If a decoder does not have this first key, no new key will be installed.

According to an operation mode, this first key is the key that is used for matching with the security unit. As indicated above, it can be of a symmetric or asymmetric type. In the second case, the secret key will be placed in the security unit and the public key in the decoder.

In the same way, at the time of the preparation of the coded message, the new asymmetric key will be coded by the secret key corresponding to the first public key of said decoder.

A supplementary verification is applied by the updating programme, verification being based on the unique decoder number. The message also contains the unique UA decoder number. This number is decoded by the shared global key. Thus, before using the first decoder key, the programme verifies if the single number is well matched to that which was foreseen.

Therefore the decoder has two personal keys, the first key and the new public key. These two keys are used in the matching mechanism with the security unit.

In order to guarantee the proper working order of the set, the security unit must also receive a new private key that corresponds to the new public key received by the decoder. For that, it disposes of security means for the security transmission of this key that is then loaded into this unit's non-volatile memory.

A supplementary security level can be added to the encryption using a system key, by encrypting this private key by the first key. Therefore, each message becomes unique and bound with the condition that the first key is known.

This structure allows the development of a security using one security key, towards a security using two keys (or more) without breaking the updating mechanism.

At this point in the process, it is recommended to verify if the received key is correct, and for this purpose a constant identifier known by the updating programme is added to the new asymmetric key. Therefore, this programme verifies that the key is valid before being introduced into its memory.

In practice, it is the decoder security unit that receives the encrypted message and transmits it to the decoder. When this unit is matched with the decoder, the transmitted message is encrypted by the first key which is the matching key.

1. Security updating method applied to the connection between a decoder and its security unit comprising a first matching key, said decoder being connected to a managing centre, this method having the following steps:
transmission in the targeted decoders, a shared public key and an updating programme,
preparation at the managing centre and for each decoder, of a encrypted message, this message containing a new asymmetric public key encrypted by the first key of said decoder and by the shared secret key,
carrying out of the updating programme and extraction of the new asymmetric public message key thanks to the global public key and its first key,
storage of this new public key in the decoder.

2. Method according to claim 1, characterized by the fact that the first key is of a symmetric type.

3. Method according to claim 1, characterized by the fact that the first key is of an asymmetric type, the new asymmetric public key is encrypted by the first secret key corresponding to the first public key of said decoder.
